(19) United States
(12) Patent Application Publication
(10) Pub. No.: US 2026/0261803 A1
(43) Pub. Date: Sep. 3, 2026

(54) SPEAKER UNIT

(71) Applicant: Mayht Holding B.V., Goleta, CA (US)

(72) Inventor: Timothy Ruben Scheek, Rotterdam (NL)

(21) Appl. No.: 19/423,507

(22) Filed: Dec. 17, 2025

Related U.S. Application Data
(63) Continuation of application No. 18/557,514, filed on May 12, 2021, now Pat. No. 12,507,017.

(51) Int. Cl. H04R 9/06; H04R 7/18; H04R 9/02

(52) U.S. Cl. CPC H04R 9/06; H04R 7/18; H04R 9/025; H04R 2400/11

(57) ABSTRACT

A speaker unit comprising a speaker frame with a major front surface and an opposing major back surface, a membrane movably arranged in the major front surface along a main speaker axis substantially perpendicular to the major front surface; one or more drive units configured to drive the membrane, wherein each drive unit of the one or more drive units comprises a driver static part and a driver moving part, wherein the driver static part is mounted to the speaker frame and wherein the driver moving part is connected to the membrane; wherein the driver static part comprises an tubular shell enclosing a chamber and having one or more magnets arranged in the chamber, and wherein the driver moving part is moveably arranged along the tubular shell.

### CROSS-REFERENCE TO RELATED APPLICATIONS

This application is a continuation of U.S. Patent Application No. 18/557,514, filed October 26, 2023, which is a 371 U.S. national phase application of International Application No. PCT/NL2021/050308, filed May 12, 2021, each of which is incorporated herein by reference in its entirety.

### FIELD OF THE INVENTION

The present invention relates to a speaker.

### BACKGROUND ART

Prior art electrodynamic loudspeakers use magnets and a magnetic circuit of pole pieces, a back plate and a top plate, which channel the magnetic field into a magnetic gap. In the magnetic gap a voice coil is positioned which is mechanically coupled to a conus producing the sound waves. Other principles are used in loudspeakers of the electrostatic type and planar loudspeakers. For electrodynamic type of loudspeakers, the inductance increases when increasing the power capacity of the loudspeaker, the sensitivity is relatively limited and the structure requires a large format in view of the maximum sound level that can be produced.

The electrostatic and planar type of loudspeakers have a disadvantage of a limited dynamic range and a bad low frequency response. In the manufacturing process of a loudspeaker, several steps are needed to assemble the static driver part, comprising of at least the magnet, and elements such as pole pieces, back plates and top plates.

### SUMMARY OF THE INVENTION

The present invention provides for an improved speaker unit. The speaker unit is cost effective to manufacture and allows for modular design.

The present invention seeks to provide an improved speaker unit solving at least in part the aforementioned problems, wherein the speaker unit has a simple structural design, and hence have advantages over prior art speaker units in both technical sense and in cost efficiency. In accordance with the present invention, a more powerful and efficient speaker unit is provided without having a too high inductance, i.e. power can be increased without a (significant) increase in inductance. Further, the speaker unit exhibits a high level of modularity in that membrane drivers with varying performance specifications can be cost-effectively produced and modularly assembled into the speaker unit efficiently to meet specific customer demands.

According to the present invention, a speaker unit as defined above is provided comprising a speaker frame with a major front surface and an opposing major back surface, a membrane movably arranged in the major front surface along a main speaker axis substantially perpendicular to the major front surface; one or more drive units configured to drive the membrane, wherein each drive unit of the one or more drive units comprises a driver static part and a driver moving part, wherein the driver static part is mounted to the speaker frame and wherein the driver moving part is connected to the membrane; wherein the driver static part comprises an tubular shell enclosing a chamber and having one or more magnets arranged in the chamber, and wherein the driver moving part is moveably arranged along the tubular shell.

### SHORT DESCRIPTION OF DRAWINGS

The present invention will be discussed in more detail below, with reference to the attached drawings, in which

FIG. 1 shows a cross section of a speaker unit according to an embodiment of the present invention;

FIG. 2 shows a 3D-view of a driver static part of a drive unit according to a first embodiment of the present invention;

FIG. 3 shows a cross section of a driver static part of a drive unit according to the first embodiment of the present invention;

FIG. 4A and 4B each show a 3D-view of a driver static part of a drive unit according to a second embodiment of the present invention;

FIG. 5 shows a cross section of a driver static part of a drive unit according to the second embodiment of the present invention;

FIG. 6A and 6B each show a 3D-view of a driver static part of a drive unit according to a third embodiment of the present invention;

FIG. 7 shows a cross section of a driver static part of a drive unit according to the third embodiment of the present invention.

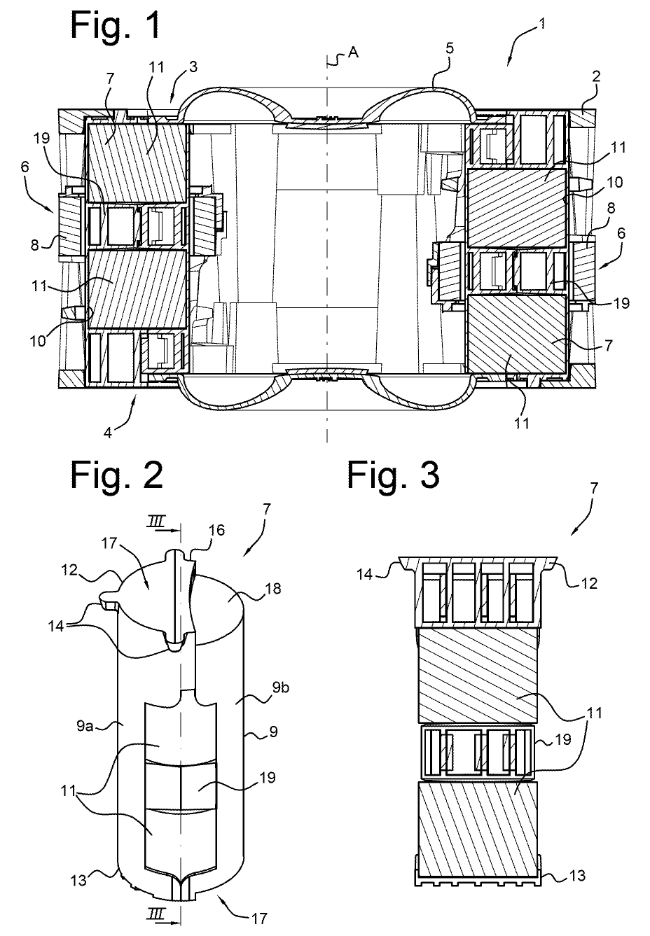

### DESCRIPTION OF EMBODIMENTS

The present invention provides for an improved loudspeaker unit having a simple structural design, and hence have advantages over prior art loudspeakers in both technical sense and in cost efficiency. Prior art electrodynamic loudspeakers use magnets and a magnetic circuit of pole pieces, a back plate and a top plate, which channel the magnetic field into a magnetic gap. In the magnetic gap a voice coil is positioned which is mechanically coupled to a conus producing the sound waves. Other principles are used in loudspeakers of the electrostatic type and planar loudspeakers. For electrodynamic type of loudspeakers, the inductance increases when increasing the power capacity of the loudspeaker, the sensitivity is relatively limited and the structure requires a large format in view of the maximum sound level that can be produced. The electrostatic and planar type of loudspeakers have a disadvantage of a limited dynamic range and a bad low frequency response. In the manufacturing process of a loudspeaker, several steps are needed to assemble the static driver part, comprising at least the magnet, and in the principles as described above, elements such as pole pieces, back plates and top plates. In accordance with the present invention embodiments, a more powerful and efficient loudspeaker unit is provided without having a too high inductance, i.e. power can be increased without a (significant) increase in inductance. Furthermore, due to the absence of a closed magnetic circuit, the dimensions of the loudspeaker unit can be relatively small. Since the loudspeaker of the present invention has multiple motors, and within the magnet circuit per driver static part, at least two magnets which are interacting with each other, it is beneficial to have the driver static part be a self-containing sub-assembly. This sub-assembly comprises the elements needed to facilitate the correct positioning of the several magnets along the longitudinal axis and axes perpendicular to the longitudinal axis. the first alignment direction is important to create as high as possible linear motion over the full excursion range of the driver moving part. The second alignment direction is important to prevent ‘rub and buzz’ (physical contact between the driver static part and the driver moving part), which would decrease the sound quality and eventually break the loudspeaker. Furthermore, the sub-assembly facilitates the space needed between the multiple magnets within the sub-assembly. It could be facilitated by a separate part which is mounted in the sub-assembly, or the shell which holds the magnets facilitates the magnet distance itself.

In a loudspeaker which comprises at least one driver static part which in its turn comprises multiple magnets that are magnetically interacting with each other, it is not possible to magnetize the driver static part after the multiple magnets are assembled into the driver static part (in the assembly process of a conventional speaker magnetization happens after several assembly steps are made to increase the convenience of assembly). The magnets used are pre-magnetized. The present invention allows for convenient manufacturing of the sub-assembly within the speaker frame, since the magnets which are interacting with each other, are now fixed in place within the sub-assembly, and are not able to move in relation to each other. There are no pushing or pulling magnetic forces involved when creating the assembly of the driver static part and the frame.

The driver static part sub-assembly comprises several elements on the areas that are being mounted within the speaker frame, which facilitate correct alignment between the frame, driver static part and the driver moving part.

The driver static part sub-assembly has several exemplary embodiments:
1. A single shell with a small wall thickness, having a height which is dictated by the height of the multiple magnets, the magnet separation distance, and the thickness of the top and bottom part of the shell. At least one of the sides of the shell needs to be open so the content of the shell can be added: the multiple magnets and the magnet separator. This open side needs to be sealed after the contents are added, to assure that the contents remain in place.
2. A shell which is cut perpendicular to the longitudinal axis, comprising a top shell part, a shell connecting part, and a bottom shell part. The shell connecting part facilitates the magnet distance between the multiple magnets.
3. A shell which is cut along the longitudinal axis, the shell itself facilitating the magnet separation distance, and the seal from both ends of the shell. Since the magnets are being mounted from the side instead of from the top, there is no need for a separate lid on top of the shell.

Turning to the figures, showing a speaker unit 1 according to the present invention comprising a speaker frame 2 with a major front surface 3 and an opposing major back surface 4, a membrane 5 movably arranged in the major front surface 3 along a main speaker axis A substantially perpendicular to the major front surface 3. One or more drive units 6 are configured to drive the membrane 5, wherein each drive unit of the one or more drive units 6 comprises a driver static part 7 and a driver moving part 8, wherein the driver static part 7 is mounted to the speaker frame 2 and wherein the driver moving part 8 is connected to the membrane 5. Wherein the driver static part 7 comprises a tubular shell 9 enclosing a chamber 10 and having one or more magnets 11 arranged in the chamber 10, and wherein the driver moving part 8 is moveably arranged along the tubular shell 9.

According to the invention, the tubular shell 10 allows convenient placement of magnets 11 in the driver static part 7 in modular fashion. That is, according to specification the magnets 11 can be chosen accordingly and conveniently placed in the tubular shell 9, which is then easily connected to the speaker frame 2.

Referring to the figures, in an embodiment, the driver static part 7 comprises a first end 12 and an opposing second end 13 for being mounted to the speaker frame 2, wherein the first and/or the second end 12, 13 comprises one or more protrusions 14, 15 and the speaker frame 2 comprises associated surface recesses for congruent engagement with the respective one or more protrusions 14, 15.. The one or more protrusions 14, 15 allow for convenient orientation of the driver static part 7 and as such proper orientation of the magnet 11.

As shown in FIG. 2, 6A, 6B, in an embodiment the one or more protrusions 14 are arranged along an outer perimeter 16 of the first and/or second end 12, 13 for congruent engagement with the speaker frame 2.

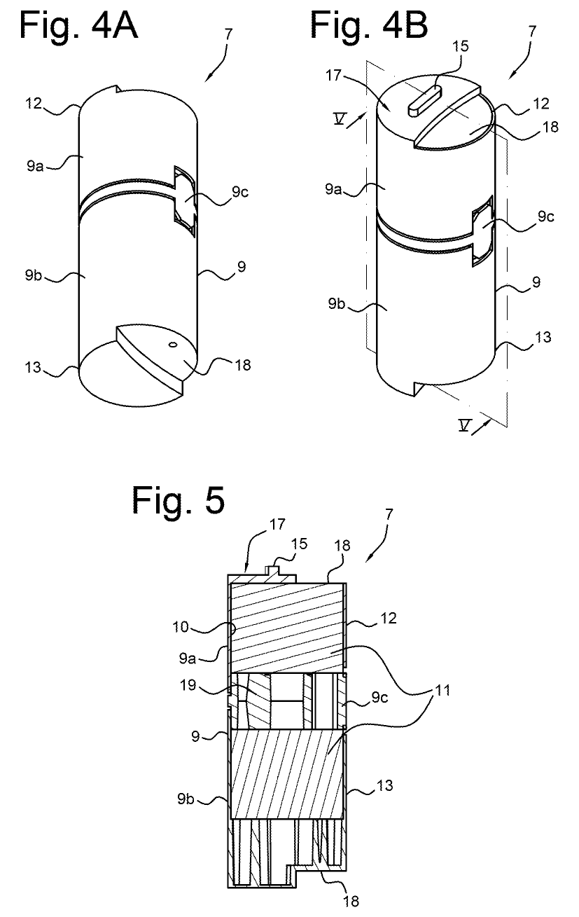

As shown in FIG. 4A, 4B, in an embodiment the one or more protrusions 15 are arranged along an end side 17 of the first and/or second end 12, 13, the end side 17 being perpendicular to the main speaker axis A.

The one or more protrusions 14, 15 allow for cooperative engagement with the speaker frame 2, e.g. with the front and back major surface 3, 4, to facilitate accurate alignment of the driver static part 7 with respect to the speaker frame 2.

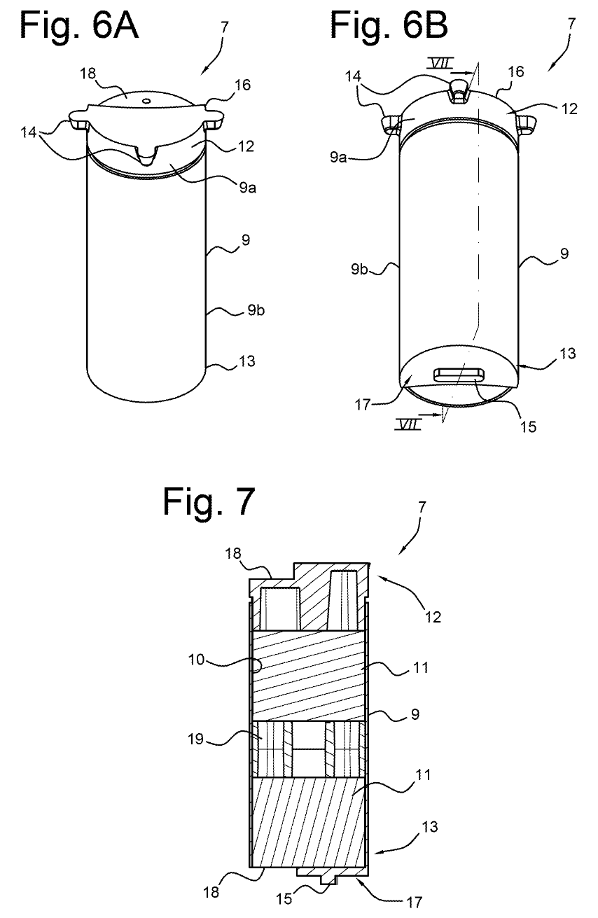

As shown in FIG. 2 to 7, in an embodiment the first and/or second end 12, 13 comprises a recess 18 for receiving a peripheral part of the membrane 5. This also allows for further secure alignment of the driver static part 7 with respect to the speaker frame 2.

In an embodiment, the tubular shell 9 comprises a first and a second shell part 9a, 9b, wherein the first and second shell parts 9a, 9b are connected together enclosing the chamber 10.

Having two shell parts 9a, 9b allows for easy placement of magnets 11 in the tubular shell 9 and in particular the chamber 10 thereof, thereby facilitating the assembly process in modular manner.

As shown in FIG. 2 and 3, in an embodiment the first and second shell parts 9a, 9b are longitudinally connected to one another along the main speaker axis A forming a longitudinal split tubular shell 9.

As shown in FIG. 4 to 7, in an embodiment the first and second shell parts 9a, 9b are connected to one another laterally with respect to the main speaker axis A forming a lateral split tubular shell.

In an embodiment, the speaker unit 1 further comprises a shell connecting part 9c arranged between the first and the second shell parts 9a, 9b. See FIGS. 4A, 4B, and 5. The shell connecting part 9c may allow good connection between the first and the second shell parts 9a, 9b and may allow convenient placement and/or spacing of the one or more magnets in the chamber 10.

In an embodiment, the tubular shell 9 comprises a non-magnetic spacer member 19 arranged in the chamber 10 configured for positioning and/or spacing apart of the one or more magnets 11 in the chamber 10.

In an embodiment, wherein the tubular shell 9 comprises a shell opening configured to have access to the chamber 10. This provides easy access to the chamber 10 for placing the one or more magnets 11.

In an embodiment, the first and/or the second shell part 9a, 9b comprises the shell opening for easy placement of the magnets 11. That is, the first and/or second shell parts 9a, 9b may be provided with a sufficiently large opening to allow convenient placement of the one or more magnets 11.

In an embodiment, the tubular shell 9 is made of non-magnetic material, e.g. plastic material, to not interfere with magnetic fields.

In an exemplary embodiment, the tubular shell 9 has a minimum wall thickness of 0.01 mm and a maximum wall thickness of 5 mm. This provides for a sufficiently small and slender form factor yet provide sufficient strength to the tubular shell 9.

The present invention has been described above with reference to a number of exemplary embodiments as shown in the drawings. Modifications and alternative implementations of some parts or elements are possible, and are included in the scope of protection as defined in the appended claims.

1. An audio transducer assembly comprising:
a frame with a first surface that is perpendicular to a first axis;
a membrane movably arranged with respect to the first surface; and
one or more drive units configured to drive the membrane, each of the one or more drive units comprising:a driver static part coupled to the frame, the driver static part having an outer surface, wherein the driver static part comprises:(i) a plurality of magnetic elements; and(ii) a non-magnetic material,wherein the non-magnetic material and the plurality of magnetic elements are fixed in place relative to one another; and a driver moving part coupled to the membrane and radially surrounding the outer surface of the driver static part, wherein the driver moving part is arranged to move with respect to the outer surface of the driver static part in a direction aligned with the first axis.

2. The audio transducer assembly of claim 1, wherein the non-magnetic material separates the plurality of magnetic elements.

3. The audio transducer assembly of claim 2, wherein the non-magnetic material positions and spaces apart the plurality of magnetic elements within the driver static part.

4. The audio transducer assembly of claim 2, wherein the driver static part further comprises a shell surrounding the plurality of magnetic elements and non-magnetic material.

5. The audio transducer assembly of claim 1, wherein the non-magnetic material comprises a plastic material.

6. The audio transducer assembly of claim 1, wherein the plurality of magnetic elements comprises a first region of magnetic elements and a second region of magnetic elements.

7. The audio transducer assembly of claim 1, wherein the driver static part comprises one or more alignment features.

8. The audio transducer assembly of claim 7, wherein the one or more alignment features are arranged to position the driver static part with respect to a) a first alignment direction aligned with the first axis and b) a second alignment direction different from the first alignment direction.

9. The audio transducer assembly of claim 1, wherein the driver static part comprises a self-contained sub-assembly.

10. The audio transducer assembly of claim 9, wherein the self-contained sub- assembly comprises a magnet circuit absent a pole piece, a back plate and a top plate.

11. The audio transducer assembly of claim 1, wherein the driver static part has a tubular shape.

12. The audio transducer assembly of claim 1, wherein the plurality of magnetic elements comprise anisotropic magnetic elements.

13. The audio transducer assembly of claim 1, wherein the non-magnetic material holds the plurality of magnetic elements at a fixed distance relative to one another.

14. The audio transducer assembly of claim 1, wherein the frame has a second surface that is perpendicular to the first axis, the audio transducer assembly comprising:
a second membrane movably arranged with respect to the second surface; and
one or more second drive units configured to drive the second membrane, each of the one or more second drive units comprising:
a driver static part coupled to the frame, the driver static part having an outer surface, wherein the driver static part comprises:(i) a plurality of magnetic elements; and(ii) a non-magnetic material, wherein the non-magnetic material and the plurality of magnetic elements are fixed in place relative to one another; and a driver moving part coupled to the second membrane and radially surrounding the outer surface of the driver static part, wherein the driver moving part is arranged to move with respect to the outer surface of the driver static part in a direction aligned with the first axis.

15. A driver static part for an audio transducer assembly, the driver static part comprising:
(i) a plurality of magnetic elements; and
(ii) a non-magnetic material,
wherein the non-magnetic material and the plurality of magnetic elements are fixed in place relative to one another.

16. The driver static part of claim 15, wherein the driver static part comprises a self-contained sub-assembly.

17. The driver static part of claim 15, wherein the non-magnetic material separates the plurality of magnetic elements.

18. The drive static part of claim 15, wherein the non-magnetic material comprises a plastic material.

19. The driver static part of claim 15, comprising one or more alignment features.

20. A drive unit for an audio transducer assembly, the drive unit comprising:
a driver static part having an outer surface, the driver static part comprising:(i) a plurality of magnetic elements; and(ii) a non-magnetic material,wherein the non-magnetic material and the plurality of magnetic elements are fixed in place relative to one another; and
a driver moving part radially surrounding the outer surface of the driver static part, wherein the driver moving part is arranged to move with respect to the outer surface of the driver static part.
